(19) United States
(12) Patent Application Publication
(10) Pub. No.: US 2008/0127685 A1
(43) Pub. Date: Jun. 5, 2008

(54) Manual Unlocking Unite for a Sliding Door

(75) Inventors: Arne Liebscher, Herdecke (DE); Andreas Finke, Gevelsberg (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co.KG, Ennnepetal (DE)

(21) Appl. No.: 11/793,832

(22) PCT Filed: Dec. 2, 2005
(86) PCT No.: PCT/EP05/12901

§ 371 Date: Jun. 22, 2007

(30) Foreign Application Priority Data
Dec. 22, 2004 (DE) 10 2004 062 995.1

(51) Int. Cl. E05B 65/08

(52) U.S. Cl. 70/95; 70/266

(57) ABSTRACT

A manual unlocking unit for a sliding door is disclosed. The unlocking unit includes a pivotable lever element comprising a plurality of abutments; a cable having a first end connectable to an unlocking device for the sliding door and a second end connected to the lever element, the cable being tensioned to actuate the unlocking device; and an actuating element actable on at least one of the plural abutments for pivoting the lever element. Each of the plural abutments is configured for receiving a tension or pressure actuating force from the actuating element.

The invention relates to a manual unlocking unit for a sliding door, with a Bowden cable, which is tension-resistantly connected to an unlocking device at the one end and, at the other end, to a manually pivotable lever element, the pivoting of the lever element being accomplished by means of an actuating element acting on the lever element

Regularly, the drive of modern sliding doors is electric; the same applies to the arresting of the travelling leaves in the closed or opened positions. Usually an activation through appropriately energizing stable or bistable electromagnets is employed for the locking or unlocking itself. An optional manual unlocking component is desirable or required for the purpose of reliable operability.

A manual unlocking unit of the species mentioned at the beginning is disclosed in DE 41 24 944 A1. In the prior art device, a traction rod is provided which, via an angled lever, actuates a Bowden cable, i.e. there is only one disposition possibility for the actuating element formed as a traction rod, such that a more suitable, different disposition of the actuating element, for example based on structural conditions or on the practicability of manipulation, can not be considered.

The same applies to the manual locking device according to DE 195 01 420 C1, where the locking or the unlocking, controlled by a bi-stable electromagnet, can be complemented by a manual unlocking device, with the electromagnet not being energized. Here again, the connection of the Bowden cable to the mounting plate does not allow for a more suitable, different disposition or for a another choice of an actuating element. Disclosed is merely the replacement of the Bowden cable by a rod assembly, what is likewise valid in equivalent terms for the subject matter of the application.

It is the object of the invention to improve a manual unlocking unit of the species mentioned at the beginning in that, with a basically identical configuration of the manual unlocking unit and thus of the pivotable lever element as well, different actuating elements can be employed.

The invention solves the given problem with the teaching according to claim 1.

According to the measure of associating several abutments to the same lever element for the optional tension-resistant and/or pressure-resistant application of an actuating element, the actuating element, with the manual unlocking unit having the same configuration, can be formed, for example, in a known manner as a traction element; in particular with the actuating element being supported inside the inner covering of the driving profile, the use of a push-button can prove to be advantageous, because, in this case, there is no tension-resistant connection to the abutment, which constitutes a component of the pivotable lever element, such that the above mentioned connection does not need to be released, if the inner covering is required to swing out for the purpose of necessary installation or maintenance work. Depending on structural conditions, the choice of the actuating element is possible, in each case likewise depending on the aspect of safety including visual requirements (a push-button as actuating element is hardly visible) or on the practicability of the manipulation.

Further preferred embodiments of the invention are indicated in the dependent claims.

In a development of the invention, two abutments, offset by 90°, are disposed at the lever element, each abutment having apertures for the tension-resistant connection of a Bowden cable. The offset by 90° allows for the optional connection of the Bowden cable—which may be substituted by a lever assembly as an equivalent—to the one or to the other abutment respectively, requiring simply to pivot the lever element by 90° prior to installation. An appropriate disposition of the actuating elements—as a rule inside the inner covering of the driving profile—allows furthermore for forming the actuating element optionally as a push-button acting on a contact surface of an abutment or as a traction rod, which is tension-resistantly connected to an aperture of an abutment.

The abutments themselves may consist of flange-like cranks disposed at a base plate of the lever element; since an automatic reset of the pivoting element, after being charged by the push-button or by the traction rod, is required, a return spring is employed in a known manner, the pivoting path for the actuation of the push-button or of the traction rod, as well as for the charging through the return spring is limited by stop dogs, which are disposed at a mounting plate accommodating the pivoting axle of the lever element.

It has proven to be suitable to support the push-button and/or the traction rod axially displaceable in a bushing, which is disposed inside an inner covering of the driving profile. Thus, in the preferred embodiment, only the actuating element is supported inside the inner covering; the manual unlocking unit itself is connected to the driving profile. Basically, also the manual unlocking device could bear on the inner covering, what allows for a more precise association of the actuating elements to the abutments, what in return is disadvantageous in that, in the event of dismounting the covering, the Bowden cable or the manual unlocking unit need to be uninstalled. This does not affect the basically optional use of different actuating elements. The same applies to the structural development of the actuating elements; in this case, the actuation of the abutments can be realized for example via a rotating knob mounted to the rear side inside the covering and having an eccentric part, which acts on the abutments.

In adaptation to the different development of the inner covering—in particular to its height—it is further suggested in the invention that an extension, which is adjustable against the abutment, be disposed at the push-button.

As a consequence of the tension-resistant connection of the traction rod to the associated abutment, it has proven to be suitable that the traction rod be connected to an adapter component, which is tension-resistantly connected to the abutment and disposed within the inner covering. Releasing the traction rod from the adapter component allows for unhindered swinging out the inner covering when maintenance or repair work is required.

The possibility of pivoting the lever element by 90° and thus the possibility of pivoting the abutments by 90° allows for the optional connection of the Bowden cable or of a corresponding rod assembly to one of the two abutments respectively, each abutment having a bore for the purpose of attaching the Bowden cable.

As a result, the invention proposes a solution, in which, with an absolutely identically formed pivoting element, differently formed actuating elements can be optionally used, while matching respective requirements.

Hereinafter, the invention will be explained in more detail on the basis of two exemplary embodiments.

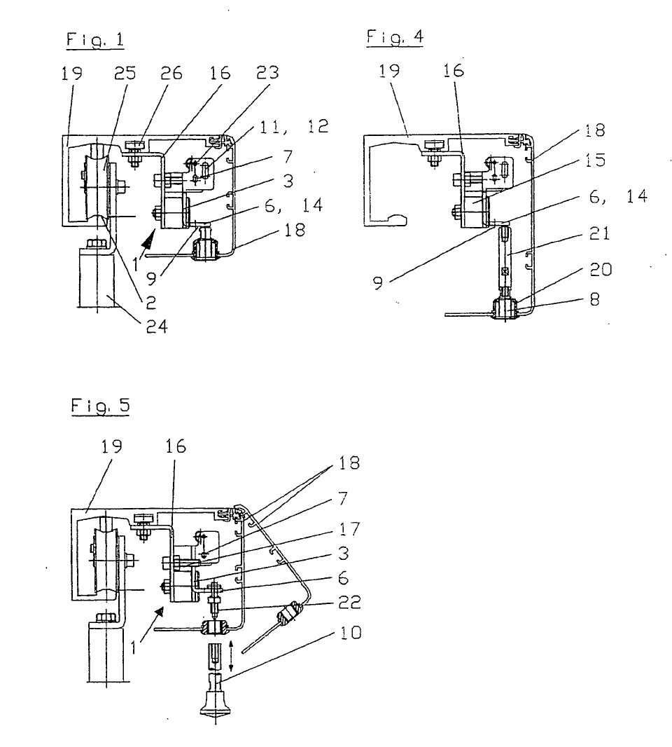

FIGS. 1 to 4 and 8 show in a first exemplary embodiment,

FIG. 1 a vertical cross section through the manual unlocking unit using a push-button,

FIG. 2 a view, offset by 90° with regard to FIG. 1, of the manual unlocking unit with the non-activated push-button,

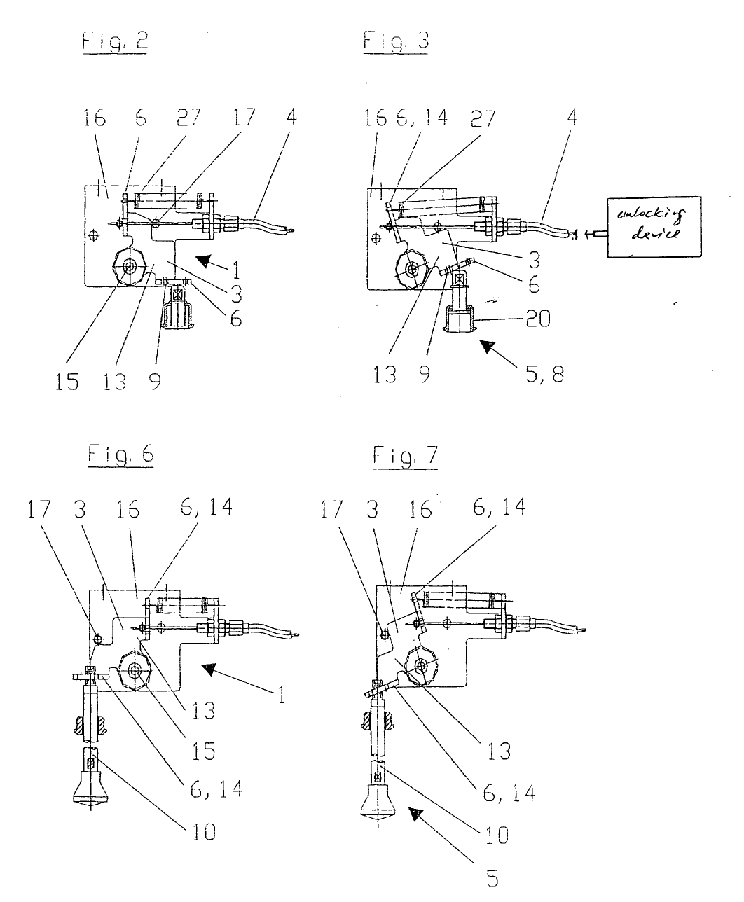

FIG. 3 a view according to FIG. 2 with the activated push-button,

FIG. 4 a view according to FIG. 1 with a push-button extension,

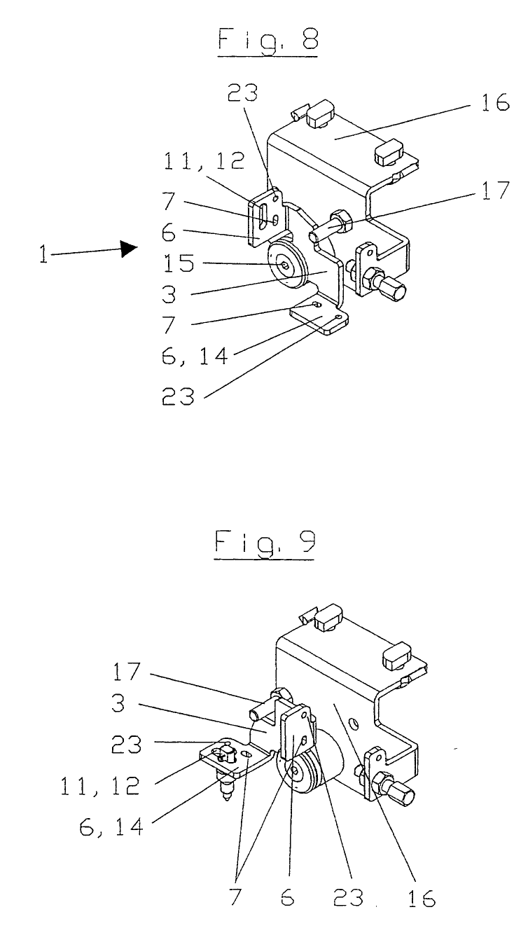

FIG. 8 a perspective illustration of the manual unlocking unit using a push-button according to FIGS. 1 to 4,

FIGS. 5 to 7 and 9 show a second exemplary embodiment,

FIG. 5 a vertical cross-section through the manual unlocking unit using a traction rod that is separable,

FIG. 6 a view, offset by 90° with regard to FIG. 5, of the manual unlocking unit with the non-activated traction rod,

FIG. 7 a view according to FIG. 6 with the activated traction rod, and

FIG. 9 a perspective illustration of the manual unlocking unit using a traction rod according to FIGS. 5 to 7.

The manual unlocking unit 1 according to FIG. 1 shows the driving profile 19 in a cross-section, in which the travelling leaf 24 is guided by means of a carrying roller 25. Both the manual unlocking unit 1, via mounting plate 16, and the inner covering 18 are connected to the driving profile 19 by means of an attachment device 26.

According to FIGS. 2 and 3, the manual unlocking unit 1 essentially consists of a lever element 3, pivotable by 90° about a pivot axis 15, which has abutments 6, likewise offset by 90°, which are constituted by cranks 14 of the base plate 13. A Bowden cable 4, which passes through an aperture 7, is connected to one of the two abutments 6 and is returned by means of a spring 27. The actuating element generally indicated at 5 is formed as a push-button 8 in FIGS. 1 to 4, which acts on a contact surface 9 of the abutment 6. The push-button 8 is axially displaceably supported in a bushing 20 passing through the inner covering 18. In adaptation to an inner covering 18 having an increased height, according to FIG. 4, an extension 21 adapted to the structural height of the inner covering 18 is associated to the push-button 8 by means of a screw connection.

The pivot path of the lever element 3 is limited in both pivot directions by stop dogs 17 respectively.

In the exemplary embodiment according to FIGS. 5 to 7, a traction rod 10 is used as an actuating element 5. With its free end, the traction rod 10 passes through an aperture 11 formed as an oblong hole 12 in the abutment 6 and is thus secured against rotation about its longitudinal axis. It can be seen, that, according to FIGS. 5 to 7, the Bowden cable 4, after pivoting the base plate 13 of the lever element 3, now acts on the abutment 6, which is offset by 90°.

As, in contrast to the push-button 8, the traction rod 10 acts tension-resistantly on the abutment 6, as shown in FIG. 5, an axial separation of the traction rod 10 is required in the direction of the arrow, in order to allow for swinging the inner covering 18 out, for the purpose of maintenance or repair work. For this purpose, an adapter component 22 is provided, which is secured to the abutment 6 and releasably connected to the traction rod 10.

### LIST OF REFERENCES

1 manual unlocking unit
2 running surface
3 lever element
4 Bowden cable
5 actuating element
6 abutments
7 apertures
8 push-button
9 contact surface
10 traction rod
11 aperture
12 oblong hole
13 base plate
14 cranks
15 pivoting axle
16 mounting bracket
17 stop dog
18 inner covering
19 driving profile
20 bushing
21 extension
22 adapter component
23 bore
24 travelling leaf
25 carrying roller
26 attachment device
27 spring

1.-12. (canceled)

13. A manual unlocking unit for a sliding door, comprising:
a pivotable lever element comprising a plurality of abutments;
a cable having a first end connectable to an unlocking device for the sliding door and a second end connected to the lever element, the cable being tensioned to actuate the unlocking device; and
an actuating element actable on at least one of the plural abutments for pivoting the lever element,
wherein each of the plural abutments is configured for receiving a tension or pressure actuating force such that the pivotable lever element is configurable for receiving a tension actuating force in a first configuration and for receiving a pressure actuating force in a second configuration.

14. The manual unlocking unit of claim 13, wherein the plural abutments comprise two abutments which are offset from each other by 90° relative to a pivoting axis of the pivotable lever element.

15. The manual unlocking unit of claim 14, wherein each of the two abutments has a first aperture, the cable being connected to one of the two abutments through the first aperture thereof, the actuating element being actable on the other of the two abutments.

16. The manual unlocking unit of claim 15, wherein the other of the two abutments has a contact surface, the actuating element comprising a push-button which is actable on the contact surface of the other of the two abutments to transmit a pressure actuating force from the actuating element to the other of the two abutments.

17. The manual unlocking unit of claim 15, wherein the other of the two abutments has a second aperture, the actuating element comprising a traction rod, the traction rod being attached to the other of the two abutments with an end thereof extending through the second aperture to transmit a tension actuating force from the actuating element to the other of the two abutments.

18. The manual unlocking unit of claim 17, wherein the second aperture is oblong-shaped.

19. The manual unlocking unit of claim 14, wherein the lever element comprises a base plate and two flange-shaped cranks on the base plate, the cranks forming the two abutments.

20. The manual unlocking unit of claim 13, further comprising a mounting plate on which the lever element is pivotably mounted, and a stop dog which is mounted on the mounting plate for delimiting a pivot path of the lever element.

21. The manual unlocking unit of claim 16, wherein the push-button is axially displaceably supported in a bushing which is supported by and disposed inside an inner covering.

22. The manual unlocking unit of claim 17, wherein the traction rod is axially displaceably supported in a bushing which is supported by and disposed inside an inner covering.

23. The manual unlocking unit of claim 16, further comprising an adjustable extension which is mounted on the push-button and actable on the contact surface of the other of the two abutments.

24. The manual unlocking unit of claim 17, further comprising an adapter component which is connected to the other of the two abutments and disposed within an inner covering, the traction rod being releasably connected to the adapter component.

25. The manual unlocking unit of claim 15, wherein the one of the two abutments has a bore, the cable extending through the first aperture and the bore of the one of the two abutments and being connected to a return spring.

26. The manual unlocking unit of claim 13, wherein the cable comprises a Bowden cable.
